(19) United States
(12) Patent Application Publication
(10) Pub. No.: US 2017/0163821 A1
(43) Pub. Date: Jun. 8, 2017

(54) DATA QUOTA MANAGEMENT FOR WIRELESS COMMUNICATION SYSTEMS

(71) Applicant: Alcatel-Lucent USA Inc., Murray Hill, NJ (US)

(72) Inventors: Charles R. Payette, Oceanport, NJ (US); Glenn R. Bruns, Naperville, IL (US); Bruce R. Cilli, Atlantic Highlands, NJ (US); Atul Divekar, Naperville, IL (US)

(21) Appl. No.: 14/958,422

(22) Filed: Dec. 3, 2015

(51) Int. Cl. H04M 15/00; H04W 4/24

(52) U.S. Cl. CPC H04M 15/885; H04W 4/24; H04M 15/8016; H04M 15/723; H04M 15/8214

(57) ABSTRACT

A wireless service provider server includes a transceiver to provide data for transmission to and receive data from one or more subscribers to a wireless service plan at a quality-of-service (QoS). The wireless service provider server also includes a processor to modify the QoS for the at least one subscriber based on a comparison of data usage by the at least one subscriber during a time interval specified by the wireless service plan and an elapsed portion of the time interval.

### BACKGROUND

Field of the Disclosure

The present disclosure relates generally to wireless communication systems and, more particularly, to data usage in wireless communication systems.

Description of the Related Art

Wireless service providers (WSPs) typically offer cellular service plans that allocate a monthly quota of data usage to subscribers for a fixed cost. Data usage includes any data sent by or received from the WSP by a device associated with the subscriber. For example, a WSP may offer data plans that provide a quota of 1 GB per month, 3 GB per month, 5 GB per month, 10 GB per month, or more. Overage charges are applied to any data usage that exceeds the quota established by the subscriber's data plan. Subscribers often find it necessary to reduce their wireless data usage towards the end of the month to avoid exceeding the quota of the data plan and incurring overage charges. This problem can be exacerbated in shared or family data plans that allow multiple users to share the monthly quota of data. For example, one heavy user of data intensive applications such as Netflix, Vine, Skype, or FaceTime may consume a large percentage of the monthly quota and force other users to curtail their usage or incur overage charges. Some family data plans set individual limits on the data usage by different members, but this defeats the purpose of having a shared data plan because heavy users cannot make use of the unused data allocated to lighter users.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a wireless communication system according to some embodiments.

FIG. 2 is a diagram of a data structure that stores configuration parameters for a wireless service plan according to some embodiments.

FIG. 3 is a plot of usage of data by user equipment operated by one or more subscribers to a wireless service plan according to some embodiments.

FIG. 4 is a plot of usage of data by user equipment operated by three subscribers to a wireless service plan according to some embodiments.

FIG. 5 is a diagram of a message exchange that is performed by entities in a wireless communication system to modify a QCI level according to some embodiments.

FIG. 6 is a diagram of a message exchange that is performed by entities in a wireless communication system to modify an AMBR according to some embodiments.

FIG. 7 is a flow diagram of a method for modifying a QoS of user equipment in response to excessive data usage according to some embodiments.

FIG. 8 is a block diagram of a wireless communication system that selectively modifies QoS for subscribers to a wireless service plan according to some embodiments.

### DETAILED DESCRIPTION

The likelihood of exceeding a data usage quota and incurring overage charges can be reduced by modifying a quality-of-service (QoS) for providing data to one or more wireless subscribers associated with a wireless service plan based on a comparison of data usage by the one or more wireless subscribers during a time interval specified by the wireless service plan and an elapsed portion of the time interval. For example, a WSP server may reduce the QoS for a first wireless subscriber in response to the first wireless subscriber consuming a percentage of the data usage quota that exceeds a first time-dependent threshold determined based on the elapsed portion of the time interval. In some embodiments, the first time-dependent threshold is equal to a percentage of the time interval that has elapsed reduced by an offset value, such as 5%. For another example, the WSP server may reduce the QoS for some or all of a group of wireless subscribers in response to the group of wireless subscribers consuming a percentage of the data usage quota that exceeds a time-dependent threshold determined based on the elapsed portion of the time interval. In some embodiments, the group time-dependent threshold is equal to a percentage of the time interval that has elapsed reduced by an offset value, such as 20%. The QoS of one or more wireless subscribers can also be increased in response to a decrease in their data usage relative to the elapsed portion of the time interval. The QoS of a wireless subscriber can be modified by changing the QoS Class Identifier (QCI) level of the wireless subscriber. For example, increasing the QCI level from 8 to 9 decreases the priority of the data bearers that provide data to the wireless subscriber. The QoS of a wireless subscriber can also be modified by changing the aggregated maximum bit rate (AMBR) for the wireless subscriber. For example, decreasing the AMBR reduces the maximum bit rate for uplink or downlink data transmissions. In some embodiments, high data usage applications can be blocked for one or more wireless subscribers based on their data usage consumption. For example, cellular data usage may be disabled for selected data intensive applications at the user equipment or they could be blocked at a network gateway such as a packet data network (PDN) Gateway.

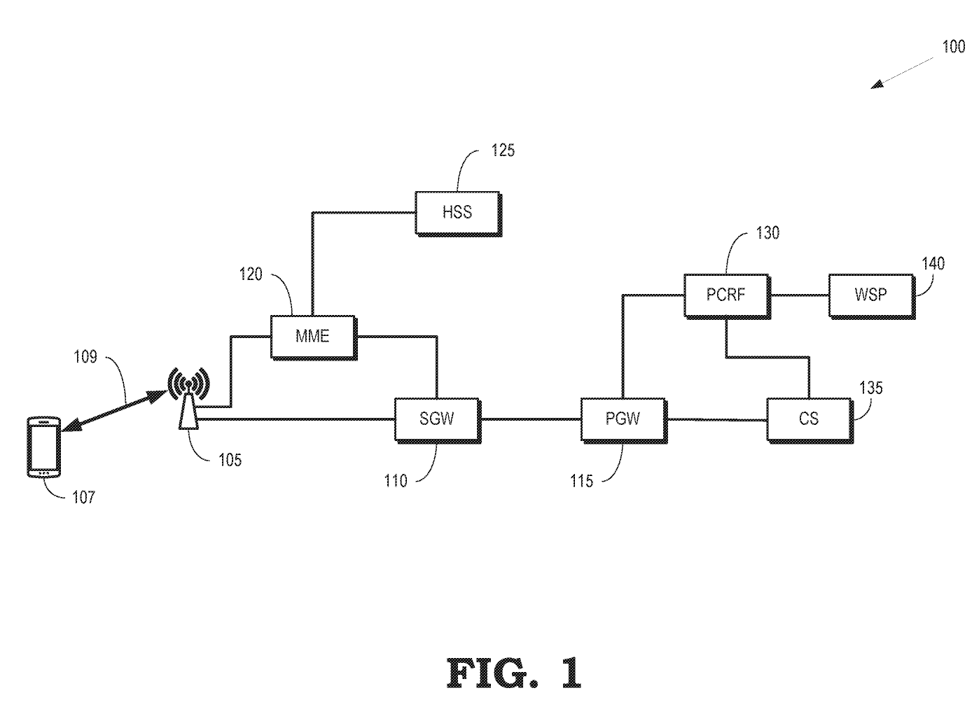

FIG. 1 is a diagram of a wireless communication system 100 according to some embodiments. The wireless communication system 100 includes one or more base stations 105 that provide wireless connectivity according to one or more radio access technologies, e.g., according to the Long Term Evolution (LTE, LTE-A) standards defined by the Third Generation Partnership Project (3GPP). As used herein, the term “base station” may be used to refer to eNodeBs, base station routers, access points, access networks, and the like. The base station 105 provides wireless connectivity to one or more user equipment 107 over corresponding air interfaces 109.

The base station 105 is connected to a gateway such as a serving gateway (SGW) 110. Some embodiments of the SGW 110 route and forward user data packets and act as a mobility anchor for the user plane during handovers between base stations, such as the base station 105 and one or more other base stations (not shown) in the wireless communication system 100. The SGW 110 may terminate the downlink data path for user equipment that are in the idle mode and may trigger paging when downlink data arrives for the idle user equipment. The SGW 110 may also manage and store contexts that include parameters to define the IP bearer service for user equipment. The SGW 110 is connected to a PDN gateway (PGW) 115. Some embodiments of the PGW 115 provide connectivity between user equipment and external packet data networks. The PGW 115 may perform policy enforcement, packet filtering for the user equipment, charging support, lawful interception, and packet screening. The PGW 115 may also be an anchor for mobility between 3GPP and non-3GPP technologies.

The base station 105 and the SGW 110 are connected to a mobility management entity (MME) 120. Some embodiments of the MME 120 are responsible for paging user equipment that are in the idle mode. The MME 120 participates in bearer activation/deactivation and is responsible for choosing a serving gateway at the initial attachment of user equipment to the wireless communication system 100. The MME 120 terminates non-access stratum (NAS) signaling for user equipment. The MME 120 may be the termination point for ciphering/integrity protection for NAS signaling in the wireless communication system 100 and may provide control plane functions for mobility between different network types. The MME 120 may also be responsible for authenticating user equipment by interacting with a Home Subscriber Server (HSS) 125, which maintains a database that contains user-related and subscription-related information, such as security keys, used to establish secure associations between user equipment and the MME 120.

The wireless communication system 100 also includes a policy control and charging rules function (PCRF) 130 that performs policy control decision-making and flow based charging control. Some embodiments of the PCRF 130 store information indicating data usage tariffs or charging policies. The charging policies may be determined based on a subscriber's charging account or an account associated with a group of subscribers.

A charging system (CS) 135 can provide data usage tariffs or policies to the PCRF 130 to indicate the data usage tariffs for subscribers to wireless service plans. For example, the CS 135 may generate data usage tariffs based on information collected by the base station 105. The CS 135 may provide the information in either a push mode (e.g., without a specific request from the PCRF 130) or a pull mode (e.g., in response to a request from the PCRF 130). The charging policies may be determined based on a subscriber's charging account or an account associated with a group of subscribers. Some embodiments of the CS 135 may determine overage charges for data usage in excess of a data usage quota for subscribers that operate the user equipment 107. The CS 135 can operate in an online mode to determine data usage charges or overage charges concurrently with consumption (or reception) of the data by the user equipment 107 or in an off-line mode to determine data usage charges or overage charges at some time subsequent to consumption (or reception) of the data by the user equipment 107.

The PCRF 130 is also connected to a wireless service provider (WSP) server 140. Some embodiments of the WSP server 140 store profiles that include information used to configure data usage quotas for individuals or groups who share a wireless service plan. The wireless service plans are associated with a primary subscriber. As used herein, the term “primary subscriber” refers to a subscriber that is responsible for a wireless service plan that may be shared by one or more subscribers. The primary subscriber may be identified within the wireless communication system 100 by a username and password combination that may be provided to the WSP server 140 (or other entity) to verify or authenticate the identity of the primary subscriber. In some embodiments, the primary subscriber configures the wireless service plan to allocate data usage quotas to the subscribers that share the wireless service plan. The primary subscriber may also configure one or more of time-dependent thresholds for modifying a quality-of-service (QoS) of the primary subscriber or one or more of the subscribers in response to data usage exceeding the corresponding time-dependent threshold, as discussed herein. The configuration information may be stored in the HSS 125, the WSP server 140, another entity, or some combination of entities. Configuration may be performed using an interface supported by the user equipment 107, the WSP server 140, or some other entity in the wireless communication system 100. Configuration may also be performed by entities that are outside the wireless communication system 100, e.g., using a wired laptop or desktop computer to access and modify the information stored in the wireless communication system 100.

Some embodiments of the WSP server 140 monitor data usage by the user equipment 107. For example, a primary subscriber may utilize the user equipment 107 to receive data over the air interface 109. The WSP server 140 may monitor data usage by the primary subscriber (and, if present, any other subscribers that share the same wireless service plan) to determine whether the amount of data consumed is less than a time-dependent threshold value that is determined based on the data usage quota established by the primary subscriber's wireless service plan, such as a time interval of one month. The time-dependent threshold may be applied to the total data usage by all the users that share the wireless service plan. Separate time-dependent thresholds may also be defined for individual users as a function of a proportion of the total data usage quota that is allocated to the individual users. Some embodiments of the time-dependent thresholds are a function of an elapsed portion of the time interval. For example, the primary subscriber may set a time-dependent threshold for total data usage equal to equal to a percentage of the time interval that has elapsed, reduced by a first offset value, such as 20%. The WSP server 140 may then monitor the total data usage by the subscribers that share the plan and compare the percentage of the total data usage that has been consumed by the subscribers to the time-dependent threshold. The WSP server 140 may also monitor individual data usage by the subscribers that share the plan and compare the percentage of the individual data usage quota that has been consumed by each of the subscribers to their corresponding time-dependent thresholds.

Some embodiments of the WSP server 140 modify a QoS for providing data to the user equipment 107 (or other user equipment in the wireless communication system 100) based on the comparison of data usage by the user equipment 107 at a particular time during a time interval specified by the wireless service plan and an elapsed portion of the time interval. For example, the WSP server 140 may reduce a QoS for providing data to the user equipment 107 in response to the user equipment 107 consuming, during the elapsed portion, a percentage of a data usage quota that exceeds the time-dependent threshold determined based on the elapsed portion, such as a percentage of the time interval that has elapsed reduced by an offset. The modified QoS may be determined so that the rate of data usage is given by:

$$\frac{{D}_{QUOTA} - {D}_{CURRENT}}{{T}_{QUOTA} - {T}_{CURRENT}} \qquad ( 1 )$$

where D_{QUOTA} is the quota of data usage specified by the wireless service plan during the time interval T_{QUOTA} and D_{CURRENT} is the amount of data usage at the current time, T_{CURRENT}. The value of D_{QUOTA} may be determined for a single subscriber or a group of subscribers that share the same wireless service plan. If the user equipment 107 consumes data at the rate given by equation (1), the user equipment 107 is expected to consume the quota of data usage D_{QUOTA} by the end of the time interval T_{QUOTA}, as required by the wireless service plan to avoid incurring overage charges. In some embodiments, the QoS is modified to limit the attainable bit rate of the user equipment 107 so that the rate of data usage is less likely to exceed the rate given by equation (1). Some embodiments of the WSP server 140 may also increase the QoS for providing data to the user equipment 107 in response to a decrease in data usage by the user equipment 107 relative to the elapsed portion of the time interval.

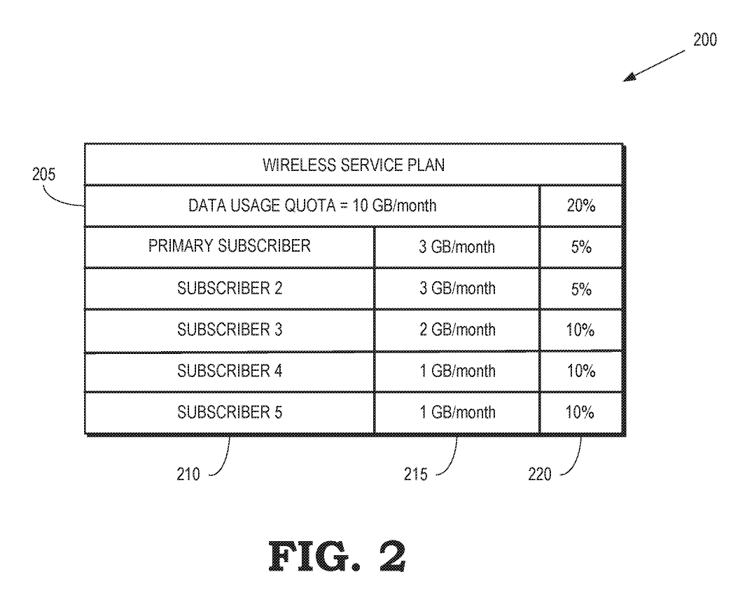

FIG. 2 is a diagram of a data structure 200 that stores configuration parameters for a wireless service plan according to some embodiments. The data structure 200 may be stored in some embodiments of the WSP server 140 shown in FIG. 1 and may be configured by a primary subscriber, as discussed herein. The data structure 200 includes a field 205 for storing a total data usage quota for the wireless service plan. For example, the field 205 indicates that the data usage quota is 10 GB that can be consumed within a time interval of one month. The data structure 200 also includes fields 210 for identifying subscribers, such as the primary subscriber and subscribers 2-5 that share the wireless service plan. Fields 215 store information that identifies portions of the total data usage quota that are allocated to the individual subscribers. The values in the fields 215 may be “hard” quotas that cannot be exceeded by the individual subscribers or they may be “soft” quotas that can be exceeded by the individual subscribers. Soft quotas may be used for the purpose of establishing time-dependent thresholds for determining whether to modify the QoS for data provided to the individual subscribers.

The fields 220 store information that identifies offsets for determining time-dependent thresholds for modifying the QoS for data provided to one or more of the subscribers that share the wireless service plan. In the illustrated embodiment, the value of the field 220 for the total data usage quota is 20%. A time-dependent threshold for modifying the QoS for data provided to the subscribers may therefore be defined as a percentage of an elapsed portion of the time interval (e.g., one month) reduced by 20%. For example, the time-dependent threshold value when 50% of the time interval has elapsed would be set equal to 40%. The QoS for data provided to the subscribers would therefore be reduced if the total data usage by the subscribers exceeded 4 GB (i.e., 40% of 10 GB) when 50% of the time interval had elapsed. The values of the field 220 for the individual subscribers indicate corresponding offsets for each of the individual subscribers. The QoS for data provided to the individual subscribers is then modified based on their individual time-dependent thresholds, which are determined based on the individual hard or soft quotas and corresponding offsets. For example, the QoS for data provided to the primary subscriber would be reduced if the data consumed by the primary user when 50% of the time interval had elapsed exceeds 1.4 GB (i.e., 95% of 50% of 3 GB). Some embodiments of the time-dependent threshold values stored in the fields 220 may be indicated by non-percentage value such as a time-dependent threshold of 9 GB for the total data usage quota 205. Thus, the QoS for one or more of the subscribers is reduced if the data usage within the time interval exceeds 9 GB.

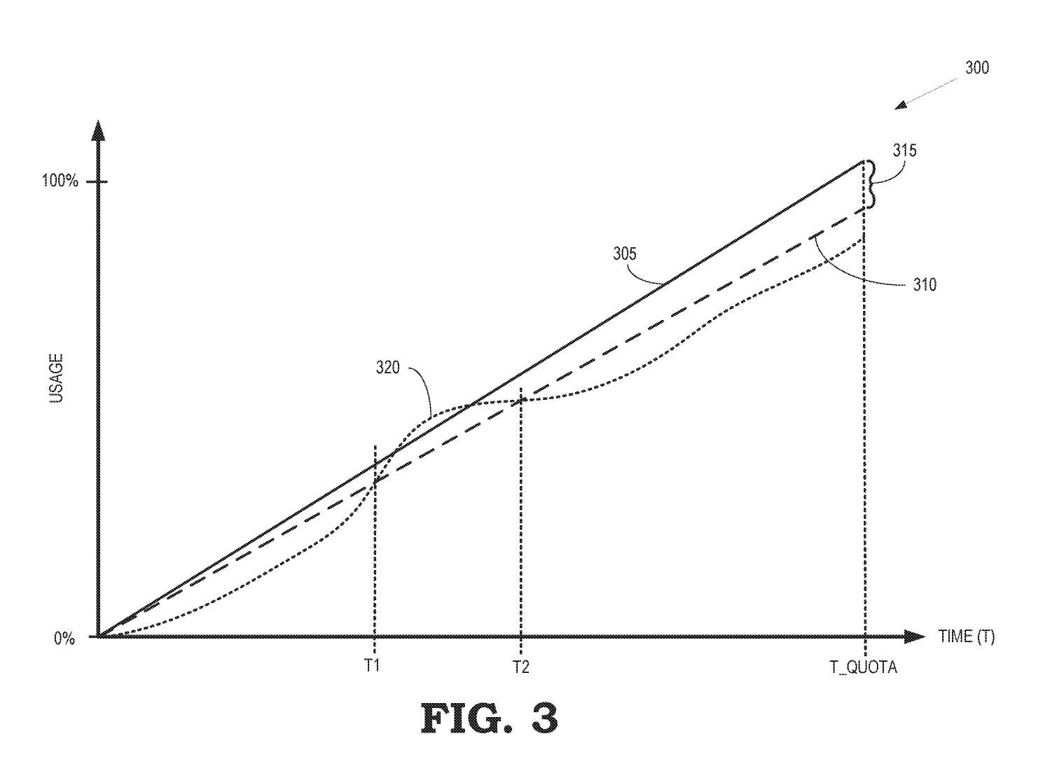

FIG. 3 is a plot 300 of usage of data by user equipment operated by one or more subscribers to a wireless service plan according to some embodiments. The vertical axis indicates data usage as a percentage of a total data usage quota shared by the one or more subscribers to the wireless service plan. The horizontal axis indicates time in arbitrary units increasing from left to right. A percentage of elapsed time 305 is determined relative to a time interval for usage of the quota, T_QUOTA. The line 305 also represents a percentage of the total data usage quota that is consumed by one or more subscribers that receive data at a constant bit rate and use the allocated quota within the time interval T_QUOTA. A time-dependent threshold 310 is determined by reducing the percentage of elapsed time 305 by an offset 315, as discussed herein. The combined data usage 320 by the one or more subscribers may then be compared to the time-dependent threshold 310 that represents a threshold percentage of the data usage, e.g., by a server such as the WSP server 140 shown in FIG. 1.

Although a single time-dependent threshold 310 and a single offset 315 are shown in FIG. 1, some embodiments may use multiple thresholds or offsets. For example, three time-dependent thresholds may be determined on the basis of three different offsets. The three time-dependent thresholds may then be used to determine when to modify the QoS levels by modifying a QCI level of the one or more the subscribers, reducing an AMBR of one or more of the subscribers, or blocking one or more applications, respectively.

At T<T1, the combined data usage 320 is less than the time-dependent threshold 310, which indicates that the one or more subscribers are not predicted to exceed the total data usage quota within the time interval T_QUOTA. The subscribers may therefore continue to consume data at their current QoS levels.

At T=T1, the combined data usage 320 exceeds the time-dependent threshold 310, which indicates that the one or more subscribers are likely to exceed the total data usage quota within the time interval T_QUOTA if they continue to consume data at the current rate. The WSP server may therefore reduce the QoS levels of one or more of the subscribers so that they consume data at a lower rate. The QoS levels may be reduced by increasing a QCI level of the one or more the subscribers, reducing an AMBR of one or more of the subscribers, or blocking one or more applications, as discussed herein.

At T=T2, the combined data usage 320 falls below the time-dependent threshold 310, which indicates that the one or more subscribers are not predicted to exceed the total data usage quota within the time interval T_QUOTA if they continue to consume data at the current rate. The WSP server may therefore maintain or increase the QoS levels of one or more of the subscribers so that they consume data at the same rate or a higher rate. The QoS levels may be maintained or increased by maintaining or decreasing a QCI level for the one or more the subscribers, maintaining or increasing an AMBR of one or more of the subscribers, or releasing one or more applications for use by the one or more subscribers, as discussed herein.

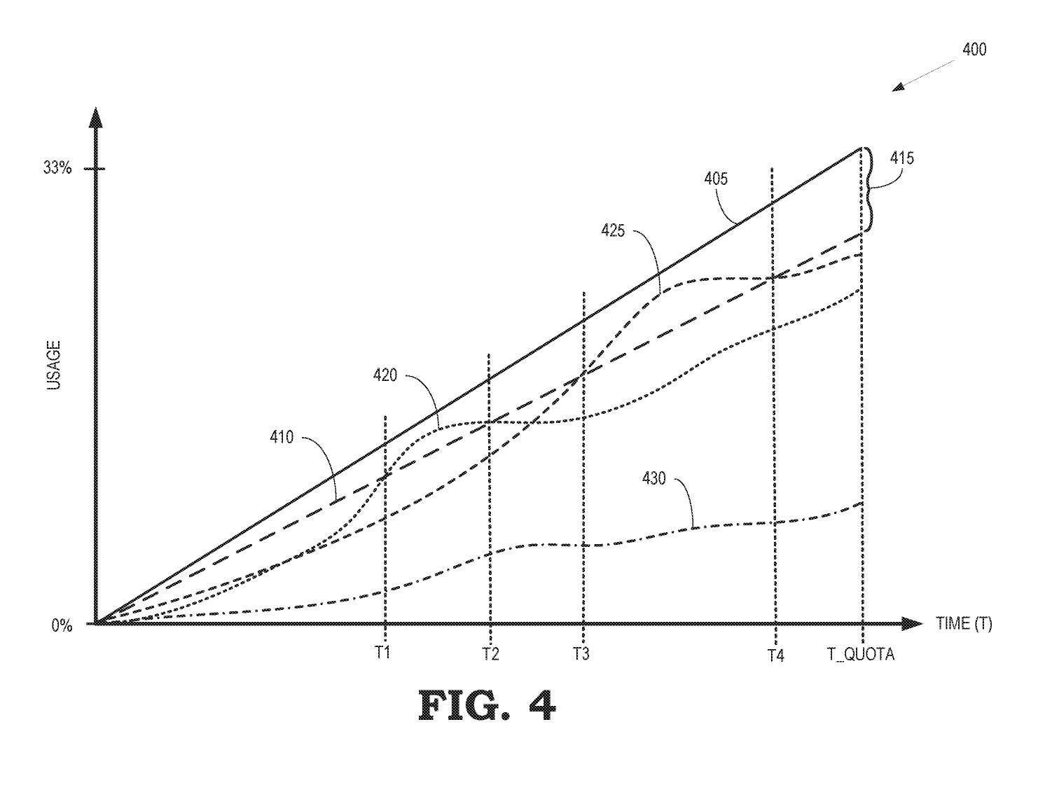

FIG. 4 is a plot 400 of usage of data by user equipment operated by three subscribers to a wireless service plan according to some embodiments. The vertical axis indicates data usage as a percentage of a total data usage quota allocated to each of the subscribers to the wireless service plan. In the illustrated embodiment, each of the three subscribers is allocated 33% of the total data usage quota for the wireless service plan. The allocation may be a hard quota or a soft quota. However, in some embodiments, the subscribers may be allocated different percentages of the total data usage quota, as discussed herein. The horizontal axis indicates time in arbitrary units increasing from left to right.

Data usage time-dependent thresholds for each of the subscribers are determined based upon a constant usage percentage 405 that represents a percentage of the subscriber's quota that is consumed by a user equipment that receives data at a constant bit rate and uses the allocated quota within the time interval T_QUOTA. A time-dependent threshold 410 is determined by reducing the constant usage percentage 405 by an offset 415, as discussed herein. The data usages 420, 425, 430 for each of the subscribers may then be compared to the time-dependent threshold 410, e.g., by a server such as the WSP server 140 shown in FIG. 1.

At T<T1, the data usages 420, 425, 430 for each of the subscribers is less than the time-dependent threshold 410, which indicates that the subscribers are not predicted to exceed their separate data usage quotas within the time interval T_QUOTA. The subscribers may therefore continue to consume data at their current QoS levels.

At T=T1, the data usage 420 for a first subscriber exceeds the corresponding time-dependent threshold 410, which indicates that the first subscriber is likely to exceed their corresponding data usage quota within the time interval T_QUOTA if they continue to consume data at the current rate. The WSP server may therefore reduce the QoS level of the first subscriber so that the first subscriber consumes data at a lower rate. The QoS level may be reduced by increasing a QCI level of the first subscriber, reducing an AMBR of the first subscriber, or blocking one or more applications used by the first subscriber, as discussed herein. The data usages 425, 430 for the second and third subscribers remain below the corresponding time-dependent threshold 410 and so the WSP server does not modify the QoS levels of these subscribers.

At T=T2, the data usage 420 of the first subscriber falls below the time-dependent threshold 410, which indicates that the first subscriber is not predicted to exceed their data usage quota within the time interval T_QUOTA if the first subscriber continues to consume data at the current rate. The WSP server may therefore maintain or increase the QoS level of the first subscriber so that the first subscriber consumes data at the same rate or a higher rate. The QoS level may be maintained or increased by maintaining or decreasing the QCI level of the first subscriber, maintaining or increasing an AMBR of the first subscriber, or releasing one or more applications used by the first subscriber, as discussed herein.

At T=T3, the data usage 425 for a second subscriber exceeds the corresponding time-dependent threshold 410, which indicates that the second subscriber is likely to exceed their corresponding data usage quota within the time interval T_QUOTA if they continue to consume data at the current rate. The WSP server may therefore reduce the QoS level of the second subscriber so that the second subscriber consumes data at a lower rate. The QoS level may be reduced by increasing a QCI level of the second subscriber, reducing an AMBR of the second subscriber, or blocking one or more applications used by the second subscriber, as discussed herein. The data usages 420, 430 for the first and third subscribers remain below the corresponding time-dependent threshold 410 and so the WSP server does not modify the QoS levels of these subscribers.

At T=T4, the data usage 425 of the second subscriber falls below the time-dependent threshold 410, which indicates that the second subscriber is not predicted to exceed their data usage quota within the time interval T_QUOTA if the second subscriber continues to consume data at the current rate. The WSP server may therefore maintain or increase the QoS level of the second subscriber so that the second subscriber consumes data at the same rate or a higher rate. The QoS level may be maintained or increased by maintaining or decreasing the QCI level of the second subscriber, maintaining or increasing an AMBR of the second subscriber, or releasing one or more applications used by the second subscriber, as discussed herein.

In some embodiments, the time-dependent threshold 410 may be used in combination with the time-dependent threshold 310 shown in FIG. 3 to determine whether to modify a QCI level of one or more of the subscribers. For example, the individual subscriber time-dependent threshold 410 and the group time-dependent threshold 310 may be used concurrently to determine whether to modify the QCI level of one or more of the subscribers early in the time interval based upon individual usage and group usage, respectively. For another example, the individual subscriber time-dependent threshold 410 may be ignored as time approaches T_QUOTA and only the group time-dependent threshold 310 may be used to determine whether to modify the QCI level of one or more of the subscribers. This approach may allow heavy users to make use of data that was allocated to lighter users but was not consumed by the lighter users.

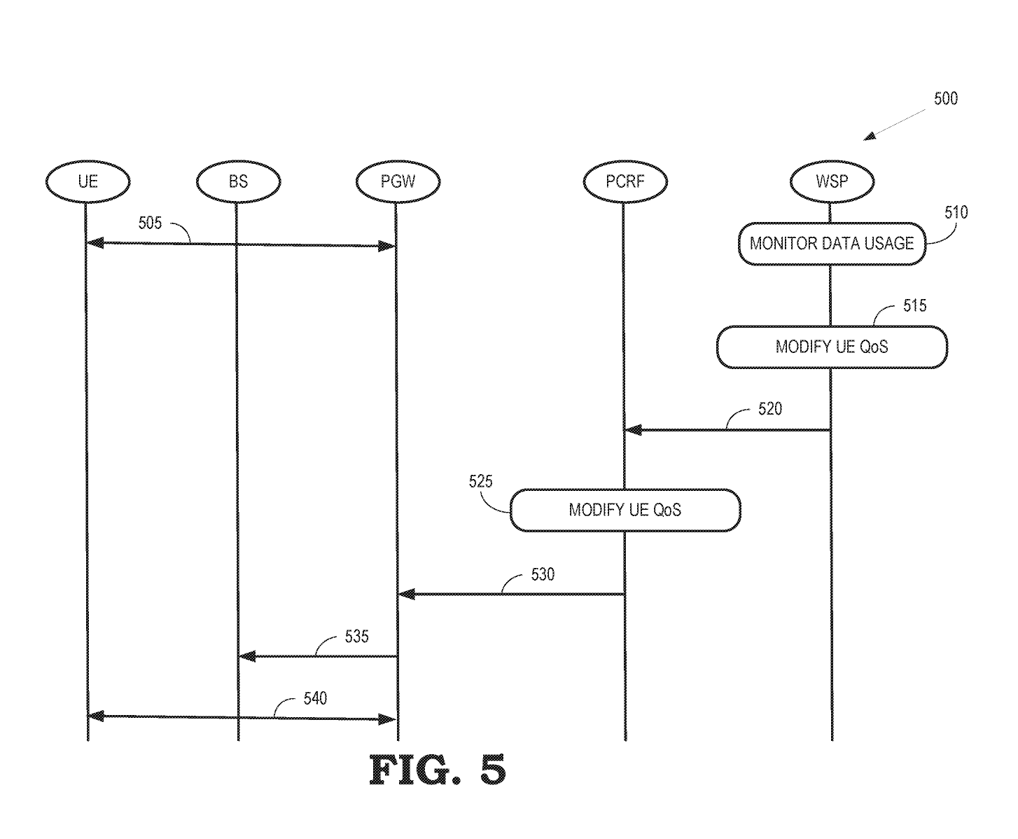

FIG. 5 is a diagram of a message exchange 500 that is performed by entities in a wireless communication system to modify a QCI level according to some embodiments. The wireless communication system includes user equipment (UE), a base station (BS), a PDN gateway (PGW), a policy charging and rules function (PCRF), and a WSP server. Thus, embodiments of the message exchange 500 may be performed by the corresponding entities in the wireless communication system 100 shown in FIG. 1.

The UE establishes a wireless communication connection with the PGW via the BS, as indicated by the double-headed arrow 505. Data is conveyed over the connection 505 at an initial QoS that is determined by a QCI level. Some embodiments of the wireless communication system define nine QCI levels that indicate different priority treatments that decrease from lower QCI levels to higher QCI levels, e.g., a QCI level of 1 gets the highest priority and a QCI level of 9 get the lowest priority. The QCI levels 7, 8, 9 are for best effort communication. The data may be conveyed over the connection 505 as best effort traffic at a QCI level of 8.

At block 510, the WSP server monitors data usage by the UE concurrently with the UE transmitting or receiving data over the connection 505. At block 515, the WSP server modifies the QoS for data conveyed over the connection 505 based on the monitored data usage. For example, the WSP server may determine that the data usage by the UE has exceeded a time-dependent threshold, as discussed herein. The WSP server may then increase the QCI level from 8 to 9 to reduce the QoS for data conveyed over the connection 505. Increasing the QCI level may encourage a subscriber that is using the UE to refrain from using high-volume data applications or to wait until the subscriber can obtain free access, e.g., via a Wi-Fi hotspot.

The WSP server transmits information indicating the modified QCI level to the PCRF, as indicated by the arrow 520. The PCRF modifies (at block 525) information indicating the QCI level and stores the information locally. The PCRF also conveys information indicating the modified QCI level to the PGW, as indicated by the arrow 530. The PGW may store the information and forward the information to the BS using conventional 3GPP messaging, as indicated by the arrow 535. The connection 505 is modified to form a modified connection 540 that conveys data at a reduced QoS that is determined by the increased QCI level of 9.

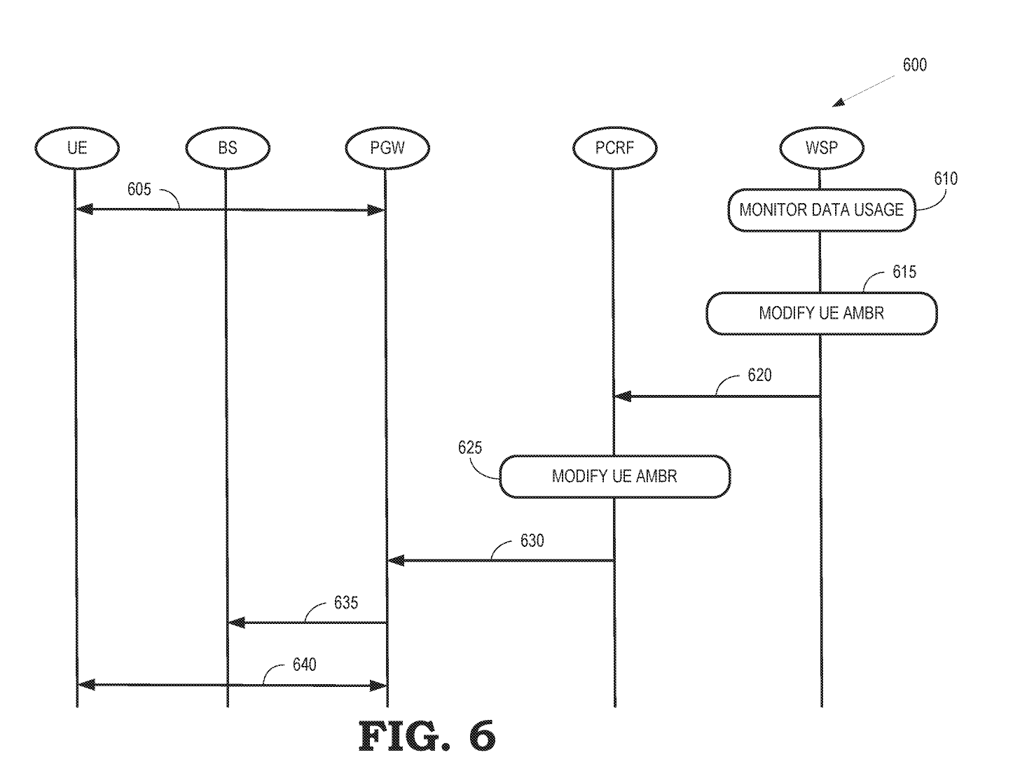

FIG. 6 is a diagram of a message exchange 600 that is performed by entities in a wireless communication system to modify an AMBR according to some embodiments. The wireless communication system includes user equipment (UE), a base station (BS), a PDN gateway (PGW), a policy charging and rules function (PCRF), and a WSP server. Thus, embodiments of the message exchange 600 may be performed by the corresponding entities in the wireless communication system 100 shown in FIG. 1.

The UE establishes a wireless communication connection with the PGW via the BS, as indicated by the double-headed arrow 605. Data is conveyed over the connection 605 at an initial QoS that is determined by an AMBR that defines the maximum bit rate the UE can obtain for all of its best effort data bearers. The AMBR may be policed for downlink traffic on the PGW and for uplink traffic on the BS.

At block 610, the WSP server monitors data usage by the UE concurrently with the UE transmitting or receiving data over the connection 605. At block 615, the WSP server modifies the QoS for data conveyed over the connection 605 based on the monitored data usage. For example, the WSP server may determine that the data usage by the UE has exceeded a time-dependent threshold, as discussed herein. The WSP server may then decrease the AMBR for the UE. Reducing the AMBR may increase file transfer times for delay-insensitive applications such as FTP applications, but would not necessarily reduce the number of bits that are transferred. Reducing the AMBR may reduce the quality of delay-sensitive streaming applications such as HTTP Adaptive Streaming (HAS) because these applications may adjust the quality or bit rates based on a perceived attainable bit rate indicated by the AMBR. For example, if the default AMBR is 5 Mbps, an HAS application running on the UE may pull data at a rate of up to 5 Mbps. However, if the AMBR is reduced to 2 Mbps, then the HAS application only pulls data at a rate of up to 2 Mbps, thereby saving 3 Mbps. Modifying the AMBR may provide incentive for the subscriber to switch to free access, e.g., via a Wi-Fi hotspot.

The WSP server transmits information indicating the modified AMBR to the PCRF, as indicated by the arrow 620. The PCRF modifies (at block 625) information indicating the AMBR and stores the information locally. The PCRF also conveys information indicating the modified AMBR to the PGW, as indicated by the arrow 630. The PGW may store the information and forward the information to the BS using conventional 3GPP messaging, as indicated by the arrow 635. The connection 605 is modified to form a modified connection 640 that conveys data subject to the constraints imposed by the reduced AMBR.

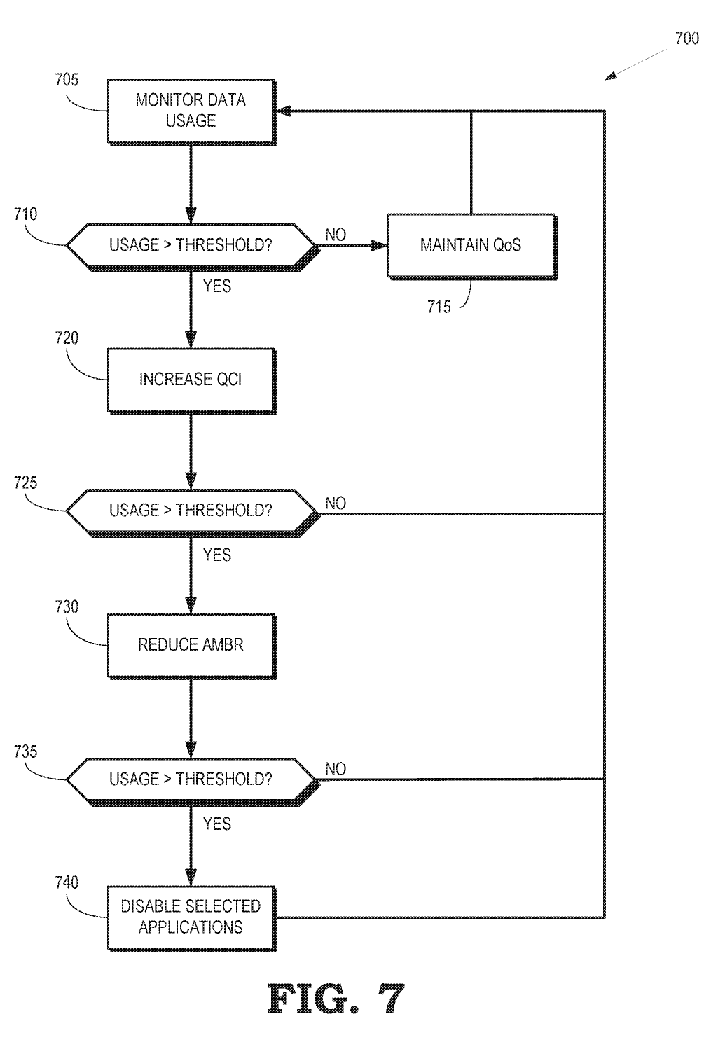

FIG. 7 is a flow diagram of a method 700 for modifying a QoS of user equipment in response to excessive data usage according to some embodiments. The method 700 may be implemented in some embodiments of the wireless communication system 100 shown in FIG. 1. Some embodiments of the method 700 may be used to modify a QoS of individual subscribers that share a wireless service plan based on individual data usage quotas or to modify the QoS of all the subscribers that share the wireless service plan based on a total data usage quota for the wireless service plan.

At block 705, the WSP server monitors data usage by one or more subscribers.

At decision block 710, the WSP server compares the data usage by the one or more subscribers to a time-dependent threshold such as the time-dependent thresholds 310, 410 shown in FIGS. 3 and 4. If the data usage is less than the time-dependent threshold, the method flows to block 715 and the QoS for the one or more subscribers is maintained at its current level. If the data usage is greater than the time-dependent threshold, the method 700 flows to block 720, and the QoS for the one or more subscribers is reduced by increasing a corresponding QCI level, e.g., from a QCI level of 8 to a QCI level of 9 as discussed herein. The method 700 then flows to decision block 725.

At decision block 725, the WSP server compares the data usage by the one or more subscribers to the time-dependent threshold to determine whether increasing the QCI level has sufficiently reduced the rate of data usage. The time interval between increasing the QCI level (at block 720) and performing the comparison at decision block 725 may be set to a predetermined time interval or a percentage of the total time interval associated with the data usage quota. If the data usage is less than the time-dependent threshold, indicating that the increase in the QCI level has successfully reduced the rate of data usage to a sustainable rate that is not predicted to incur overage charges by exceeding the data usage quota, the method 700 flows to block 705 and the WSP server continues to monitor data usage. If the data usage is greater than the time-dependent threshold, the method flows to block 730, and the QoS for the one or more subscribers is reduced by reducing a corresponding AMBR, as discussed herein. The method 700 then flows to decision block 735.

At decision block 735, the WSP server compares the data usage by the one or more subscribers to the time-dependent threshold to determine whether increasing the QCI level and reducing the AMBR has sufficiently reduced the rate of data usage. The time interval between reducing the AMBR (at block 730) and performing the comparison at decision block 735 may be set to a predetermined time interval or a percentage of the total time interval associated with the data usage quota. If the data usage is less than the time-dependent threshold, indicating that the increase in the QCI level and the reduction in the AMBR have successfully reduced the rate of data usage to a sustainable rate that is not predicted to incur overage charges by exceeding the data usage quota, the method 700 flows to block 705, and the WSP server continues to monitor data usage. If the data usage is greater than the time-dependent threshold, the method flows to block 740, and one or more applications are disabled. For example, data intensive applications such as Facebook, Netflix, Vine, and Instagram, or video chat applications such as Skype and Facetime may be selectively disabled at block 740. Functions within the data intensive applications may also be selectively disabled, e.g., by turning off automatic download of videos or images in a Facebook feed. Applications may be selectively or iteratively disabled at block 740 until the data usage falls below the time-dependent threshold. In some embodiments, policies can be applied that allow subscribers to override the block until they have reached some percentage of their monthly quota (e.g. 85%) at some percentage of time (e.g. 80%) into the billing cycle. The method 700 then flows to block 705.

Although a single time-dependent threshold is used in the method 700 shown in FIG. 7, some embodiments may use multiple thresholds. For example, three time-dependent thresholds may be determined on the basis of three different offsets. The three time-dependent thresholds may then be used to determine when to modify the QoS levels by modifying a QCI level of the one or more the subscribers, reducing an AMBR of one or more of the subscribers, or blocking one or more applications, respectively. For example, the three different time-dependent thresholds may be applied at the decision blocks 710, 725, 735.

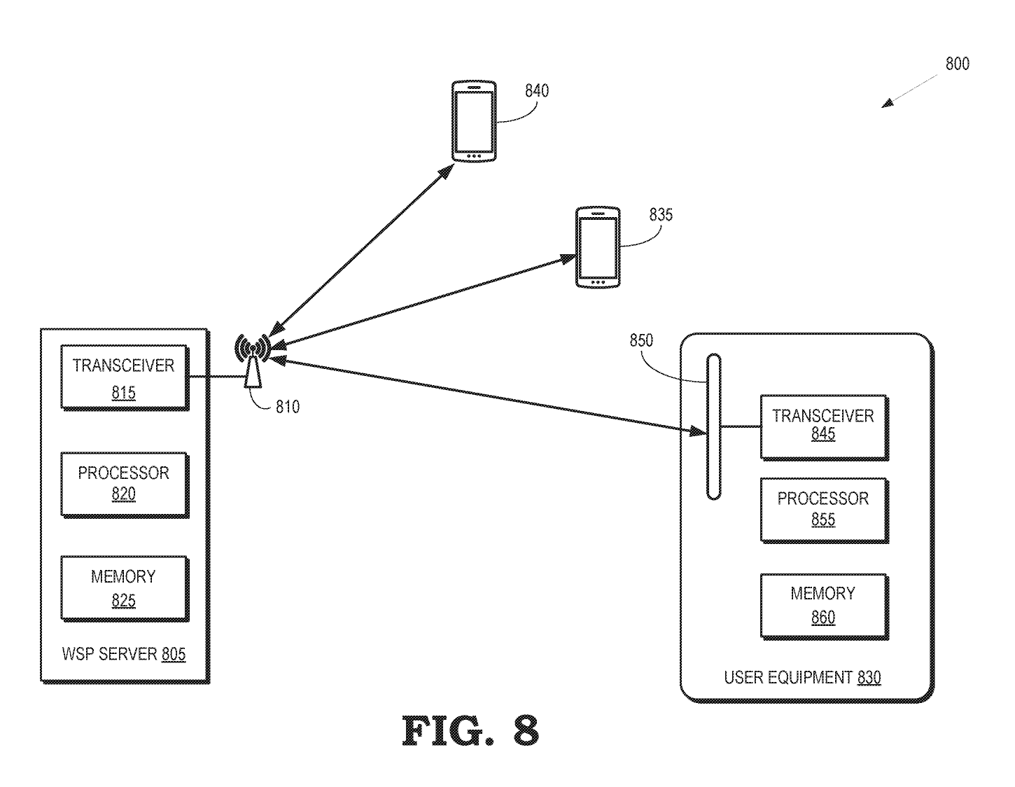

FIG. 8 is a block diagram of a wireless communication system 800 that selectively modifies QoS for subscribers to a wireless service plan according to some embodiments. The communication system 800 includes a WSP server 805 that is connected to a base station 810 to support wireless communication over an air interface. The connection may be direct or may include one or more intervening entities. The WSP server 805 and the base station 810 may be used to implement some embodiments of the WSP server 140 and the base station 105 shown in FIG. 1. The WSP server 805 includes a transceiver 815 for transmitting and receiving signals. The received signals may include uplink signals received by the base station 810 over the air interface and the transmitted signals may include downlink signals for transmission by the base station 810 over the air interface. The WSP server 805 also includes a processor 820 and a memory 825. The processor 820 may be used to execute instructions stored in the memory 825 and to store information in the memory 820 such as the results of the executed instructions. The processor 820 and the memory 825 may be configured to perform some embodiments of the method 700 shown in FIG. 7, as well as embodiments of other techniques described herein.

The wireless communication system 800 includes user equipment 830, 835, 840. The user equipment 830 includes a transceiver 845 for transmitting and receiving signals via antenna 850. The user equipment 830 also includes a processor 855 and a memory 860. The processor 855 may be used to execute instructions stored in the memory 860 and to store information in the memory 860 such as the results of the executed instructions. The processor 855 and the memory 860 may be configured to perform some embodiments of the techniques described herein, such as the method 700 illustrated in FIG. 7. The user equipment 835, 840 may include the same structural elements as the user equipment 830 and may also be configured to perform some embodiments of the techniques described herein, such as the method 700 illustrated in FIG. 7.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
modifying a quality-of-service (QoS) for providing data to and receiving data from at least one subscriber to a wireless service plan based on a comparison of data usage by the at least one subscriber during a time interval specified by the wireless service plan and an elapsed portion of the time interval.

2. The method of claim 1, wherein modifying the QoS comprises reducing the QoS for providing data to and receiving data from a first subscriber in response to the first subscriber consuming, during the elapsed portion, a first percentage of a data usage quota that exceeds a first time-dependent threshold determined based on the elapsed portion.

3. The method of claim 2, wherein the first time-dependent threshold is a percentage of data usage that is equal to a percentage of the time interval that has elapsed reduced by a first offset value.

4. The method of claim 2, wherein the first subscriber is one of a plurality of subscribers that share the data usage quota for the time interval specified by the wireless service plan, and wherein the first percentage of the data usage quota is a first percentage that is allocated to the first subscriber.

5. The method of claim 1, wherein modifying the QoS comprises reducing the QoS for providing data to at least one of a plurality of subscribers in response to the plurality of subscribers consuming, during the elapsed portion, a second percentage of a data usage quota that exceeds a second time-dependent threshold determined based on the elapsed portion.

6. The method of claim 5, wherein the second time-dependent threshold is equal to a percentage of the time interval that has elapsed reduced by a second offset value, wherein the plurality of subscribers share the data usage quota for the time interval specified by the wireless service plan.

7. The method of claim 1, wherein modifying the QoS comprises at least one of modifying a QoS Class Identifier (QCI) level for the at least one subscriber, modifying an aggregated maximum bit rate (AMBR) for the at least one subscriber, blocking at least one application used by the at least one subscriber, or selectively blocking functionality of the at least one application.

8. The method of claim 7, wherein modifying the QoS comprises:
reducing the QCI level for the at least one subscriber in response to the at least one subscriber consuming, during the elapsed portion, a third percentage of a data usage quota that exceeds a third time-dependent threshold determined based on the elapsed portion;
reducing the AMBR for the at least one subscriber in response to the third percentage exceeding the third time-dependent threshold after reducing the QCI level for the at least one subscriber; and
blocking the at least one application in response to the third percentage exceeding the third time-dependent threshold after reducing the AMBR for the at least one subscriber.

9. The method of claim 1, wherein modifying the QoS comprises increasing the QoS for providing data to or receiving data from the at least one subscriber in response to a decrease in data usage by the at least one subscriber relative to the elapsed portion of the time interval.

10. An apparatus comprising:
a transceiver to provide data for transmission to and receive data from at least one subscriber to a wireless service plan at a quality-of-service (QoS); and
a processor to modify the QoS for the at least one subscriber based on a comparison of data usage by the at least one subscriber during a time interval specified by the wireless service plan and an elapsed portion of the time interval.

11. The apparatus of claim 10, wherein the processor is to reduce the QoS for providing data to and receiving data from a first subscriber in response to the first subscriber consuming, during the elapsed portion, a first percentage of a data usage quota that exceeds a first time-dependent threshold determined based on the elapsed portion.

12. The apparatus of claim 11, wherein the first time-dependent threshold is a percentage of data usage that is equal to a percentage of the time interval that has elapsed reduced by a first offset value.

13. The apparatus of claim 12, wherein the first subscriber is one of a plurality of subscribers that share the data usage quota for the time interval specified by the wireless service plan, and wherein the first percentage of the data usage quota is a first percentage that is allocated to the first subscriber.

14. The apparatus of claim 10, wherein the processor is to reduce the QoS for providing data to and receiving data from at least one of a plurality of subscribers in response to the plurality of subscribers consuming, during the elapsed portion, a second percentage of a data usage quota that exceeds a second time-dependent threshold determined based on the elapsed portion.

15. The apparatus of claim 14, wherein the second time-dependent threshold is equal to a percentage of the time interval that has elapsed reduced by a second offset value, wherein the plurality of subscribers share the data usage quota for the time interval specified by the wireless service plan.

16. The apparatus of claim 10, wherein the processor is to modify the QoS by performing at least one of modifying a QoS Class Identifier (QCI) level for the at least one subscriber, modifying an aggregated maximum bit rate (AMBR) for the at least one subscriber, and blocking at least one application used by the at least one subscriber.

17. The apparatus of claim 10 wherein the processor is to:
reduce the QCI level for the at least one subscriber in response to the at least one subscriber consuming, during the elapsed portion, a third percentage of a data usage quota that exceeds a third time-dependent threshold determined based on the elapsed portion;
reduce the AMBR for the at least one subscriber in response to the third percentage exceeding the third time-dependent threshold after reducing the QCI level for the at least one subscriber; and
block the at least one application in response to the third percentage exceeding the third time-dependent threshold after reducing the AMBR for the at least one subscriber.

18. The method of claim 10, wherein the processor is to increase the QoS for providing data to and receiving data from the at least one subscriber in response to a decrease in data usage by the at least one subscriber relative to the elapsed portion of the time interval.

19. A non-transitory computer readable storage medium embodying a set of executable instructions, the set of executable instructions to manipulate a processor to:
modify a quality-of-service (QoS) for providing data to and receiving data from at least one subscriber to a wireless service plan based on a comparison of data usage by the at least one subscriber during a time interval specified by the wireless service plan and an elapsed portion of the time interval.

20. The non-transitory computer readable storage medium of claim 19, wherein the processor is to:
reduce the QCI level for the at least one subscriber in response to the at least one subscriber consuming, during the elapsed portion, a percentage of a data usage quota that exceeds a time-dependent threshold determined based on the elapsed portion;
reduce the AMBR for the at least one subscriber in response to the percentage exceeding the time-dependent threshold after reducing the QCI level for the at least one subscriber; and
block the at least one application in response to the percentage exceeding the time-dependent threshold after reducing the AMBR for the at least one sub scriber.
